(19) United States
(12) Patent Application Publication
(10) Pub. No.: US 2025/0036366 A1
(43) Pub. Date: Jan. 30, 2025

(54) SYSTEM CONFIGURATION DERIVATION DEVICE, SYSTEM CONFIGURATION DERIVATION METHOD, AND RECORDING MEDIUM

(71) Applicant: NEC Corporation, Minato-ku, Tokyo (JP)

(72) Inventor: Takuya KUWAHARA, Tokyo (JP)

(73) Assignee: NEC Corporation, Minato-ku, Tokyo (JP)

(21) Appl. No.: 18/836,834

(22) PCT Filed: Mar. 22, 2022
(86) PCT No.: PCT/JP2022/013172

§ 371 Date: Aug. 8, 2024

(51) Int. Cl. G06F 8/20

(52) U.S. Cl. CPC G06F 8/22

(57) ABSTRACT

A system configuration derivation device calculates a first evaluation value indicating an evaluation of a similarity between a specific embodiment rule application and a candidate of the embodiment rule application, wherein the specific embodiment rule application is included in a design history, the design history indicates a history of in a case where an embodiment configuration is obtained by repeatedly applying an embodiment rule to an abstract configuration; selects, based on a second evaluation value, a specific abstract configuration among the abstract configurations obtained by applying the embodiment rule to the new configuration one or more times, wherein the second evaluation value indicates the evaluation of the similarity with the design history, of the entirety of one or more applications of the embodiment rule until the abstract configuration is obtained from the new configuration; and repeats the embodiment rule application to the selected specific abstract configuration.

### TECHNICAL FIELD

This invention relates to a system configuration derivation device, a system configuration derivation method, and a recording medium.

### BACKGROUND ART

It has been proposed to conduct system design by repeatedly applying an embodiment rule to an abstract description of a system configuration to be designed to embody the system configuration. For example, the system configuration derivation device described in Patent Document 1, in a case where applying any of a plurality of embodiment rules to the configuration requirements of a system to be constructed, calculates a score for each pair consisting of an embodiment rule and the object to which the embodiment rule is applied, and determines the application of the embodiment rule to the configuration rule by selecting the pair based on the score.

### PRIOR ART DOCUMENTS

### Patent Document

Patent Document 1: Japanese Patent No. 6989014

### SUMMARY OF THE INVENTION

### Problems to be Solved by the Invention

In a case where designing a system by repeatedly applying an embodiment rule to an abstract description of the system configuration to be designed to embody the system configuration, it is expected that by approaching a system that has been designed in the past, one can achieve a system that is relatively close to proven systems in use, yielding a system that is relatively reliable.

An example of an object of the present invention is to provide a system configuration derivation device, a system configuration derivation method, and a recording medium that can solve the above-mentioned problems.

### Means for Solving the Problem

According to the first example aspect of the present invention, a system configuration derivation device is provided with: an embodiment rule application evaluation means that calculates a first evaluation value indicating an evaluation of the similarity between a specific embodiment rule application included in a design history showing the history of in a case where an embodiment configuration, which is a system configuration not including an abstract element, is obtained by repeatedly applying an embodiment rule to an abstract configuration, which is a system configuration including an abstract element, and a candidate of the embodiment rule application that is used for a new configuration, which is the abstract configuration of a system design target, in a case where determining the embodiment configuration; and an embodiment means that selects, among the abstract configurations obtained by applying the embodiment rule to the new configuration one or more times, a specific abstract configuration and repeats the embodiment rule application to the selected specific abstract configuration, wherein the specific abstract configuration is selected on the basis of a second evaluation value that is calculated on the basis of the first evaluation value and indicates the evaluation of the similarity, with the design history, of the entirety of one or more applications of the embodiment rule until the abstract configuration is obtained from the new configuration.

According to the second example aspect of the invention, a system configuration derivation method includes a computer calculating a first evaluation value indicating an evaluation of the similarity between a specific embodiment rule application included in a design history showing the history of in a case where an embodiment configuration, which is a system configuration not including an abstract element, is obtained by repeatedly applying an embodiment rule to an abstract configuration, which is a system configuration including an abstract element, and a candidate of the embodiment rule application that is used for a new configuration, which is the abstract configuration of a system design target, in a case where determining the embodiment configuration; and selecting, among the abstract configurations obtained by applying the embodiment rule to the new configuration one or more times, a specific abstract configuration and repeating the embodiment rule application to the selected specific abstract configuration, wherein the specific abstract configuration is selected on the basis of a second evaluation value that is calculated on the basis of the first evaluation value and indicates the evaluation of the similarity, with the design history, of the entirety of one or more applications of the embodiment rule until the abstract configuration is obtained from the new configuration.

According to a third example aspect of the invention, a recording medium records a program for causing a computer to execute calculating a first evaluation value indicating an evaluation of the similarity between a specific embodiment rule application included in a design history showing the history of in a case where an embodiment configuration, which is a system configuration not including an abstract element, is obtained by repeatedly applying an embodiment rule to an abstract configuration, which is a system configuration including an abstract element, and a candidate of the embodiment rule application that is used for a new configuration, which is the abstract configuration of a system design target, in a case where determining the embodiment configuration; and selecting, among the abstract configurations obtained by applying the embodiment rule to the new configuration one or more times, a specific abstract configuration and repeating the embodiment rule application to the selected specific abstract configuration, wherein the specific abstract configuration is selected on the basis of a second evaluation value that is calculated on the basis of the first evaluation value and indicates the evaluation of the similarity, with the design history, of the entirety of one or more applications of the embodiment rule until the abstract configuration is obtained from the new configuration.

### Effect of Invention

The present invention is expected to enable the design of systems that are relatively close to those designed in the past.

### BRIEF DESCRIPTION OF THE DRAWINGS

FIG. 1 is a block diagram showing an example configuration of the system configuration derivation device according to the first example embodiment.

FIG. 2 is a block diagram showing an example of the configuration of the system configuration derivation device according to the second example embodiment.

FIG. 3 is a drawing showing an example of an abstract configuration according to the example embodiment.

FIG. 4 is an explanatory drawing showing an example of an embodiment rule according to the example embodiment.

FIG. 5 is a drawing showing an embodiment example of applying the embodiment rule according to the example embodiment in two different ways.

FIG. 6 is an explanatory drawing showing an example of the design history according to the example embodiment.

FIG. 7 is a flowchart showing an example of the procedure by which the configuration information embodiment portion of the first example embodiment derives the embodiment configuration of the system.

FIG. 8 is a flowchart showing an example of the operation of the matching coincidence calculation portion according to the example embodiment.

FIG. 9 is a flowchart showing an example of the operation of the similarity calculation portion according to the example embodiment.

FIG. 10 is a flowchart showing an example of the procedure in which the example embodiment application/similarity reflection portion generates a list of candidate embodiments.

FIG. 11 is a flowchart showing an example of the operation of the configuration information embodiment portion according to the second example embodiment.

FIG. 12 is a drawing that shows an example of a tree searched by the configuration information embodiment portion according to the first example embodiment.

FIG. 13 is a drawing showing an example of the configuration of the system configuration derivation device according to the third example embodiment.

FIG. 14 is a drawing showing an example of the processing steps in the system configuration derivation method according to the fourth example embodiment.

FIG. 15 is a schematic block diagram showing the configuration of a computer in accordance with at least one example embodiment.

### EXAMPLE EMBODIMENT

The following is a description of example embodiments of the present invention, but these example embodiments are not intended to limit the scope of the invention as claimed. Not all of the combinations of features described in the example embodiments are essential to the solution of the invention.

### First Example Embodiment

### (Description of Configuration)

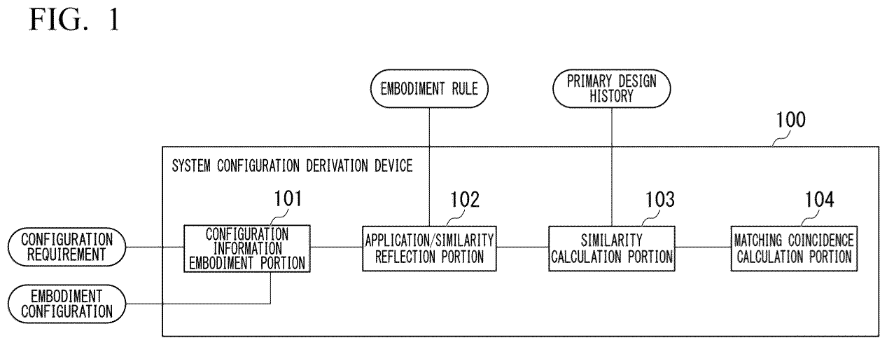

FIG. 1 is a block diagram showing an example configuration of a system configuration derivation device 100 according to the first example embodiment. In the configuration shown in FIG. 1, the system configuration derivation device 100 is provided with a configuration information embodiment portion 101, an embodiment application/similarity reflection portion 102, a similarity calculation portion 103, and a matching coincidence calculation portion 104.

The configuration information embodiment portion 101 receives an abstract configuration as input and derives an embodiment configuration by sequentially applying the applicable embodiment rules to the obtained abstract configuration.

The similarity calculation portion 103 receives the abstract configuration, design history, embodiment action, and primary design history as input, calculates the similarity between the received embodiment action and the primary design history, and also calculates a new identifier mapping for that embodiment action.

The matching coincidence calculation portion 104 receives two embodiment actions A, B and a list of identifiers (prohibited identifier list) as input, calculates the similarity between the two obtained embodiment actions, and also calculates a new identifier mapping for the embodiment action A.

The embodiment application/similarity reflection portion 102 receives abstract configurations, design history, and embodiment actions as input and returns a list of pairs that links the results of applying the embodiment actions to the acquired abstract configurations with the corresponding similarity scores.

In the following, the case in which the system configuration derivation device 100 is used to design an ICT (Information and Communication Technology) system will be described as an example. However, the application of the system configuration derivation device 100 is not limited to any particular object.

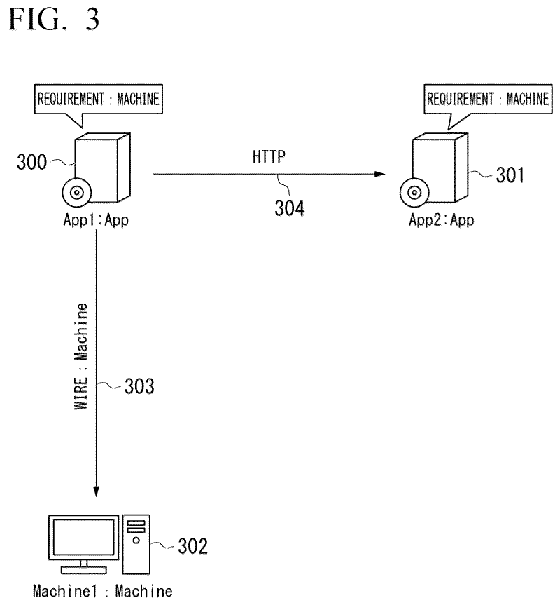

An abstract configuration according to the example embodiment and its data structure will be described. An abstract configuration here refers to an abstract system configuration that includes undetermined parts of the configuration and settings. The abstract configuration is information that is determined by the entity that desires the ICT system, for example. In other words, only information that expresses “what requirements the system should meet and what functions it should have”, by being written down by the user using a graphical user interface (GUI), for example, in the manner described below, is information that plays the role of specifying the desired system without referring specifically to the details of the system (e.g., FIG. 3: see below for details).

In other words, the abstract configuration described above is represented in the form of a graph consisting of “nodes”, which correspond to the functions and logical and physical components of the system, and “edges”, which are stretched between two nodes and express the relationship between those two nodes. Edges in an abstract configuration have an orientation. For edges from node A to node B, node A is called the “source” and node B is called the “destination”. In the following, in a case where referring to nodes and edges without distinction, they are collectively referred to as “entities”.

An entity has an “identifier” to uniquely identify the entity throughout the system and “type information” that expresses what concept the entity corresponds to. The determination of identity of entities between two different abstract configurations, such as “abstract configuration before and after embodiment” or “left side and right side of embodiment rule”, shall be performed by identifiers. In other words, even if the type information is different, if the identifiers are the same, they are treated as “the same entity”.

The “type information” associated with an entity is explained in more detail.

Type information has the role of indicating what kind of information is associated with the entity to which the type information is attached. There are two types of types: abstract and embodied. Abstract types indicate types of entities such as “Machine” and “HTTP connectable” that do not directly correspond to embodied components or connection relationships that exist in reality, but require further embodiment. On the other hand, embodied types indicate entities that correspond to embodied components or connection relationships that exist in reality, such as “(embodied machine model number)” or “wired LAN connection”.

Types have a concept of abstraction, and a concept of parent-child relationship is defined among type information based on relations such as “type t2 is more embodied than type t1”. In a case where type t2 is more embodied than type t1, we say that type t1 is the parent or parent type of type t2, and type t2 is the child or child type of type t1.

By applying the embodiment rules described below to the type of a node, the type of the node can be converted to the child type thereof. This corresponds to the operation of narrowing down the candidates so that the type of node becomes more specific according to the embodiment rules.

The node type (type of node) may also have information indicating “required components”. There may be more than one required component in one node type, or none at all.

The above is an explanation of the “type information” associated with an entity. Next, the “required components” associated with the node type are explained in more detail.

The required component associated with a node type intuitively indicates a dependent component necessary for the normal operation of the component corresponding to the node with that node type. For example, the “App” type, which indicates an application, has “Machine” as a required component. This indicates that for the application to work, a machine hosting that application is required.

The fact that a node has a node type with an associated required component is also simply expressed as the node having a required component. Extending an edge with the special embodied edge type “WIRE:req” from node N1 to a separate node N2 for a required component req possessed by node N1 enables connection of the component required by node N1 to the node N1. The description of the “req” portion here shall vary depending on the required component.

Extending this edge corresponds to the selection of node N2 as the component req required by node N1. The requirement can be fulfilled by connecting the appropriate component with respect to the required component that the node has.

For example, in the App type example above, by connecting a “WIRE:Machine” type edge from App type node MyApp to Machine type node Machine1, the host destination of node MyApp can be specified as the node Machine1.

Only one node at most may be connected to the required component of a node. For example, after connection to the node Machine1 in the previous example, the node MyApp cannot be connected to the separate Machine type node Machine2 by an additional “WIRE:Machine” type edge.

The above is an explanation of the “required component” associated with a node type.

Next, the abstract configuration shall be described.

FIG. 3 shows an example of an abstract configuration. In FIG. 3, icons marked with the reference numerals 300, 301, and 302 indicate nodes. Arrows marked with the reference numerals 303 and 304 indicate edges. Nodes are labeled with a label of the form “(identifier):(type name)”. The edges, on the other hand, are labeled with only the name of the type. Node 300 and node 301 are also marked with a callout indicating the required component. For ease of viewing the figure, information on requirements and labels is omitted where appropriate.

Nodes 300 and 301 both represent applications. Here, both node 300 and node 301 are assumed to correspond to embodied system configuration components that do not contain any undetermined parts. Both of these nodes have a “Machine” required component. The requirement for node 300 is satisfied by the connection of Machine1. On the other hand, the requirement of node 301 has not been met.

Node 302 is a node that represents “some machine”. In other words, it has been determined that node 302 is a machine that can run applications, but it has not been determined what specific product will be used here.

Edge 303 is a specific relationship edge, indicating that the source node 300 is hosted on the destination node 302. With node 302 connected to node 300 by edge 303, the “Machine” requirement for node 300 is satisfied.

Edge 304 indicates that it is guaranteed that the source node 300 can send HTTP requests in some way to the destination node 301. The edge 304 is an edge that represents an abstract relationship in that the specific communication path is undefined.

The above is a description of an embodied example of an abstract configuration.

Next, the embodiment rules shall be explained. An embodiment rule includes information representing the object of embodiment and information representing the configuration after embodiment. The information that represents the object of embodiment among an embodiment rule is called “the left-hand side (of the embodiment rule)”. The information that represents the configuration after embodiment among an embodiment rule is called “the right-hand side (of the embodiment rule)”.

The left-hand side of the embodiment rule and the right-hand side of the embodiment rule are attributed graphs, as is the basic structure of the abstract configuration.

Entities on the left and right sides of the embodiment rule must satisfy all three of the following conditions (c11), (c12), and (c13).
(c11) A node present on the left side must also be present on the right side. Condition (c11) is a constraint to ensure that the existence of parts already added to the abstract configuration by embodiment is not itself lost.
(c12) Entities of embodied types existing on the left side are not deleted. Condition (c12) is a constraint to ensure that no embodiment is made that would withdraw and rewrite a part once finalized.
(c13) For a node v that is common to both the left and right sides, “the type of v in the left side” must be the same as “the type of v in the right side” or its parent type. Condition (c13) is a constraint to ensure that the rewriting of the type of the part resulting from embodiment is only a “narrowing of the type to something more specific” and not a rewriting to a completely different type of part.

Next, how an abstract configuration is embodied by embodiment rules shall be explained.

We say that an embodiment rule r is applicable to an abstract configuration d if the abstract configuration d contains a structure corresponding to the left-hand side of the embodiment rule r. Here, “an abstract configuration d has a structure corresponding to the left-hand side of embodiment rule r” means that (c21) a subgraph of exactly the same form as the left-hand side of the embodiment rule r is contained as a subgraph of the abstract configuration d, and (c22) in the one-to-one relation between entities based on (c21) above, “the type of entity on the left-hand side of embodiment rule r” becomes the parent type of “the type of entity on the abstract configuration d side”.

The “subgraph of the abstract configuration d corresponding to the left-hand side of embodiment rule r” is referred to as the object of embodiment of the abstract configuration d by the embodiment rule r.

That is, in a case where the embodiment rule r is applicable to the abstract configuration d, then the abstract configuration d has an object of embodiment, which is a substructure that corresponds one-to-one to the left-hand side of the embodiment rule r. The rewriting of an abstract configuration d by an embodiment rule r means replacing the object of embodiment with the structure expressed by the right-hand side of the embodiment rule r.

If there exists an entity e[new] that is not on the left side of the embodiment rule but only on the right side, a new corresponding entity is basically created. However, if an entity e[reused] with the same type as the entity e[new] or child type thereof already exists in the abstract configuration in a different portion than the object of embodiment, e[reused] can be used instead of creating a new entity. This is called “reuse” of entity e[reused] in the application of the embodiment rules.

In a case where applying an embodiment rule to an abstract configuration, one can consider the correspondence between entities that represent the object of embodiment and the object of reuse. This correspondence is called the “application location” in the application of the embodiment rule. The information on the embodiment rules and their application locations is called the “embodiment action”. Embodiment actions fall under the example of application of embodiment rules.

In the case where an entity e[new] exists not on the left-hand side of the embodiment rule but only on the right-hand side, and an entity corresponding to entity e[new] is newly created, the application location may or may not contain the information about the “identifier to be assigned to e[new]”.

If such information is included, the target identifier is assigned to e[new] at the time of embodiment. If such information is not included, a new identifier not included in the applicable abstract configuration at the time of embodiment is generated, and this identifier will be assigned to the newly created entity corresponding to e[new]. In a case where two or more identifiers are newly generated, no duplication should occur even between them.

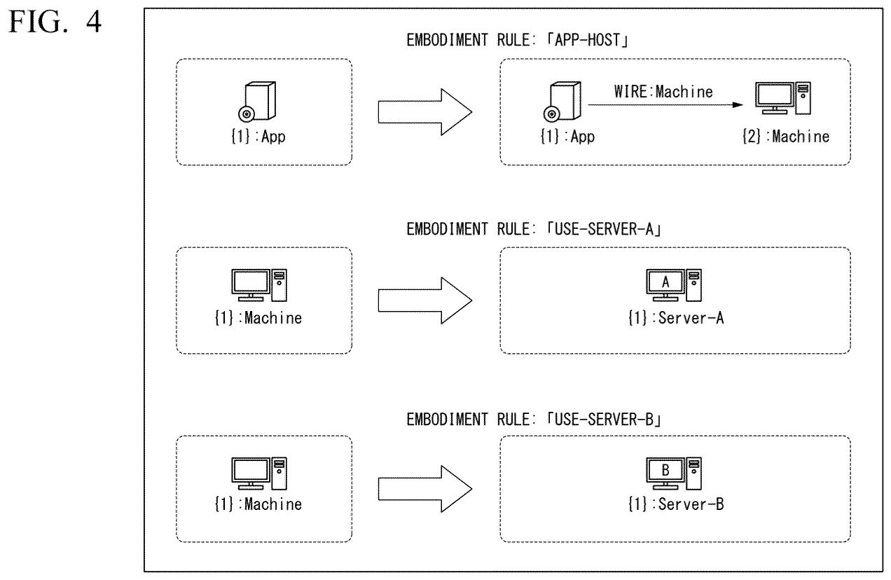

Next, the embodiment rules and their application with concrete examples will be explained. FIG. 4 shows an example of an embodiment rule. FIG. 4 shows the three embodiment rules “APP-HOST”, “USE-SERVER-A”, and “USE-SERVER-B”. In FIG. 4, the left side of the embodiment rule is shown to the left of the arrow and the right side of the embodiment rule is shown to the right.

The embodiment rule “APP-HOST” indicates that for an “App” type node for which the “Machine” requirement is not satisfied, the graph is transformed to satisfy the requirement by connecting a “Machine” type node. The embodiment rule “APP-HOST” represents the operation of connecting a “Machine” type node {2} with a “WIRE:Machine” type edge to an “App” type node {1} already included in the abstract configuration. This operation satisfies the “Machine” requirement of node {1}.

“USE-SERVER-A” indicates that the graph is to be converted so that the “Machine” type node is replaced by a “Server-A” type node. The conversion rule “USE-SERVER-A” represents the adoption of a specific server represented by a “Server-A” type node for an abstract machine represented by the “Machine” type node.

“USE-SERVER-B” indicates that the graph is to be converted so that the “Machine” type node is replaced by a “Server-B” type node. The conversion rule “USE-SERVER-B” represents the adoption of a specific server represented by a “Server-B” type node for an abstract machine represented by the “Machine” type node.

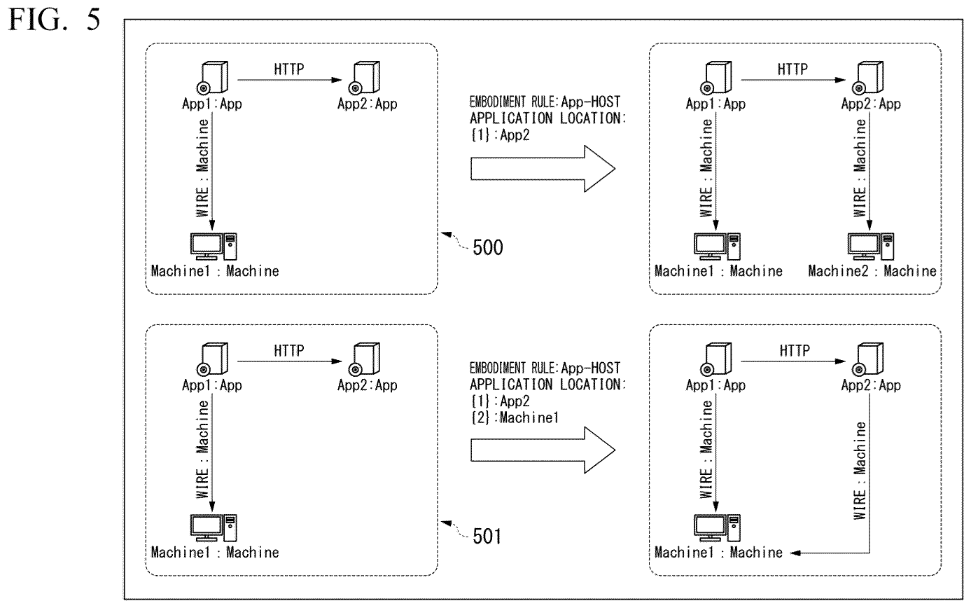

FIG. 5 is a drawing showing a concrete example of applying the embodiment rule “APP-HOST” in the two different ways described in FIG. 3.

Application example 500 is a case where the embodiment rule “APP-HOST” is applied to the application location “{1}:App2”. In Application example 500, the embodiment rule “APP-HOST” is applied by mapping node {1} in the embodiment rule to node App2 in FIG. 3. A new Machine type node corresponding to {2} is created and given the identifier “Machine2”.

On the other hand, application example 501 is a case where the embodiment rule “APP-HOST” is applied to the applicable location “{1}:App2, {2}:Machine1”. In application example 501, the node “Machine1” is being reused, and the existing node “Machine1” is used as a Machine type node corresponding to the node {2}, which exists only on the right-hand side of the embodiment rule “APP-HOST”.

Thus, for the same embodiment rule and the same abstract configuration, multiple embodiment actions may be possible.

The above is an explanation of the rewriting of an abstract configuration by application of the embodiment rule.

Next, an embodiment configuration derived by the system configuration derivation device 100 shall be described.

An embodiment configuration here is fully embodied abstract configuration. Here, an abstract configuration is “fully embodied” if it satisfies all of the following three embodied conditions (embodied condition 1), (embodied condition 2), and (embodied condition 3).
(Embodied condition 1) The abstract configuration does not contain a single node with an abstract type.
(Embodied condition 2) The abstract configuration does not contain a single edge with an abstract type.
(Embodied condition 3) The abstract configuration does not contain a single unsatisfied requirement.

From the definitions of embodied conditions, it can be said that a fully embodied abstract configuration indicates a state where there are no ambiguous parts as an ICT system, and all the necessary components for operation are fully assembled. Therefore, the embodiment configuration would correspond to a functionally complete and operational system.

Next, the design history shall be explained.

Applying an embodiment action to an abstract configuration produces another abstract configuration that is more embodied than the original one. This procedure may be repeated multiple times.

In a case where a sequence of embodiment actions a[1], a[2], . . . , a[n] is applied in that order to an abstract configuration D1, resulting in a different abstract configuration D2, the sequence of embodiment actions a[1], a[2], . . . , a[n] is referred to as the “design history” of D2 starting from the abstract configuration D1. In a case where the starting abstract configuration D1 is such that it is self-evident from the context, the sequence of embodiment actions is also referred to simply as the “design history of abstract configuration D2”.

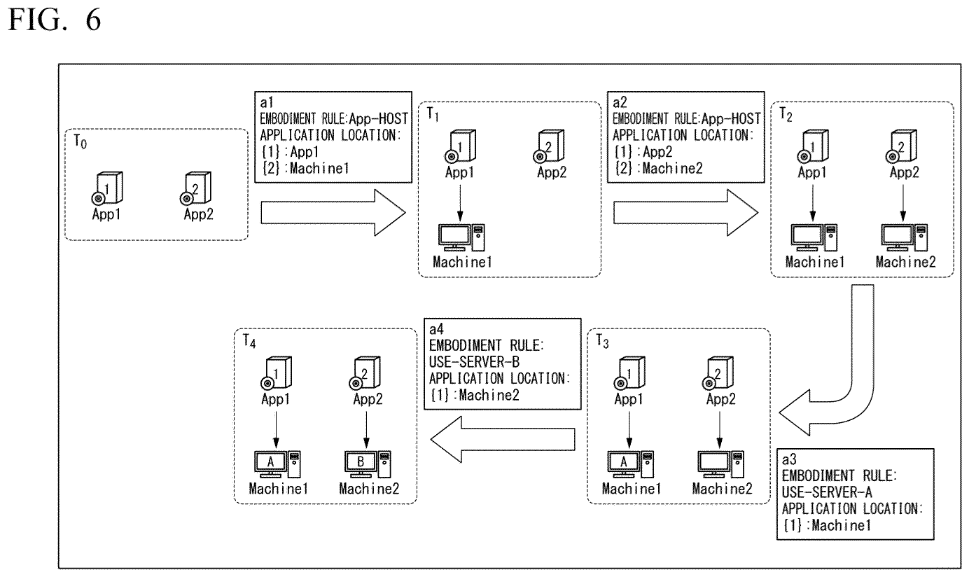

Next, the design history shall be explained using an example. FIG. 6 illustrates an example of design history.

FIG. 6 shows the process by which abstract configuration T₀ is transformed through T₁, T₂, and T₃ to finally abstract configuration T₄. FIG. 6 is an example of a design history composed of four embodiment actions a1, a2, a3, and a4.
(a1) Embodiment rule: APP-HOST, application location: {{1}:App1, {2}: Machine1}
(a2) Embodiment rule: APP-HOST, application location: {{1}:App2, {2}: Machine2}
(a3) Embodiment rule: USE-SERVER-A, application location: {{1}: Machine1}
(a4) Embodiment rule: USE-SERVER-B, application location: {{1}: Machine2}

### (Explanation of Operation)

The system configuration derivation device 100 receives as input an abstract configuration representing a requirement and outputs an embodiment configuration that satisfies the requirement indicated by the input abstract configuration. This series of processes is called the automated design process. To distinguish it from the primary requirement described below, an abstract configuration input to the system configuration derivation device 100 as the subject of calculating an embodiment configuration is referred to as a “new requirement”.

The system configuration derivation device 100 reads a list of embodiment rules to be used in the automatic design process as a pre-processing step before executing the automatic design process.

Furthermore, the system configuration derivation device 100 receives as input “primary requirements”, which are abstract configurations that represent information about requirements as well as new requirements, and “primary design history”, which is the design history of embodying primary requirements into embodiment configurations.

A supplemental explanation of the primary design history is provided below.

The primary design history may be, but is not limited to, the design history resulting from the application of the automated design process to the primary requirements as in the case of new requirements (as a side effect). For example, the design history resulting from manually composing and applying applicable embodiment actions to the primary requirements may be entered into the system configuration derivation device 100 as primary design history.

In addition, the application location of each embodiment action included in the primary design history shall have a “complete” identifier correspondence to the embodiment rule for that embodiment action, unlike the normal application location. In general, the application location of the embodiment action does not necessarily contain correspondences for all identifiers used in the embodiment rule (on the right side of the rule), and if there is no correspondence, a new identifier is generated. On the other hand, if the application location of an embodiment action included in the primary design history contains an identifier for which no correspondence relationship is defined, a correspondence relationship that indicated “what identifier is generated and assigned to that identifier (by the application of the embodiment rule in the primary design history)” shall always be included.

The embodiment configuration resulting from designing primary requirements according to the primary design history is called the “primary embodiment configuration”.

For example, the embodiment action in the application example 500 of the embodiment rule shown in FIG. 5 has the information of the application location “{1}:App2”, and the identifier “Machine2” is newly generated and assigned to {2} for which no correspondence relationship exists. If the primary design history includes information for this embodiment action, this embodiment action shall be considered to have the application location “{1}:App2, {1}:Machine2”.

The above is a supplementary explanation for the primary design history.

Next, the details of the processing of each part of the system configuration derivation device 100 shall be explained.

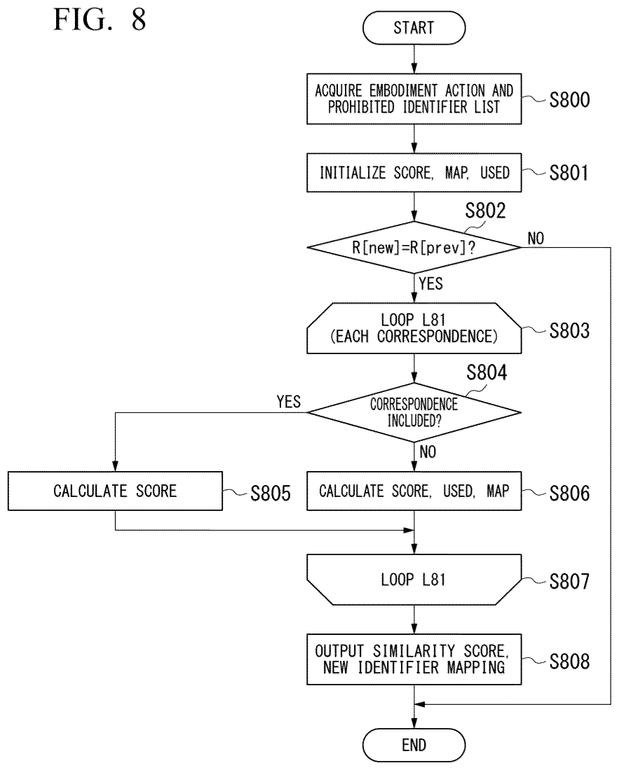

First, the operation of the matching coincidence calculation portion 104 shall be described. FIG. 8 is a flowchart showing an example of the operation of the matching coincidence calculation portion 104.

### (Step S800)

The matching coincidence calculation portion 104 takes as input two embodiment actions (a[new]: new concrete action, a[prev]: primary embodiment action), and a list of prohibited identifiers L. New embodiment action a[new] is an embodiment action that can be applied in system design by embodiment of new requirements. The primary embodiment action a[prev] is the embodiment action included in the primary design history.

Here, the embodiment action a[new] is assumed to consist of the embodiment rule R[new] and the application location M[new]. The embodiment action a[prev] shall consist of the embodiment rule R[prev] and the application location M[prev]. After Step S800, the process proceeds to Step S801.

### (Step S801)

The matching coincidence calculation portion 104 sets the initial value of SCORE to 0, the initial value of MAP to the empty identifier assignment information, and the initial value of USED to an identifier list with the same contents as the prohibited identifier list L. SCORE is a variable used to calculate the similarity score, which indicates the degree of similarity between the left-hand side of the embodiment rule and the application location. MAP is the variable for calculating the new identifier mapping. USED is the variable used for the SCORE calculation. The new identifier mapping is a list of application locations that the matching coincidence calculation portion 104 obtains by evaluating the similarity between the new embodiment action a[new] and the primary embodiment action a[prev]. Application locations included in the new identifier mapping are included by the embodiment application/similarity reflection portion 102 in candidates for application locations in the system design through the embodiment of new requirements.

Here, “identifier assignment information” is data in dictionary form that shows the correspondence between an identifier of an embodiment rule and another identifier, having the same format as the application location of the embodiment action. The “empty” identifier assignment information refers to identifier assignment information that does not contain any correspondence. After Step S801, the process proceeds to Step S802.

### (Step S802)

The matching coincidence calculation portion 104 compares the embodiment rule R[new] with the embodiment rule R[prev]. If the matching coincidence calculation portion 104 determines that the embodiment rule R[new] and the embodiment rule R[prev] are the same (Step S802: YES), the process proceeds to Step S804. On the other hand, if the matching coincidence calculation portion 104 determines that the embodiment rule R[new] and the embodiment rule R[prev] are not the same (Step S802: NO), the process proceeds to Step S808.

### (Step S803)

The matching coincidence calculation portion 104 executes loop L81, which performs the processing for each correspondence “ID[rule]:ID[prev]” included in the application location M[prev]. After Step S803, the process proceeds to Step S804.

### (Step S804)

The matching coincidence calculation portion 104 determines whether the correspondence for the identifier ID[rule] is included in the application location M[new] (Step S804). If the matching coincidence calculation portion 104 determines that the correspondence “ID[rule]:ID[new]” for the identifier ID[rule] is included in the application location M[new] (Step S804: YES), the process proceeds to Step S805. On the other hand, if the matching coincidence calculation portion 104 determines that the correspondence for the identifier ID[rule] is not included in the application location M[new] (Step S804: NO), the process proceeds to Step S806.

### (Step S805)

The matching coincidence calculation portion 104 determines whether ID[new] and ID[prev] match. If it is determined that ID[new] and ID[prev] match, the matching coincidence calculation portion 104 increases the SCORE value by 1. After Step S805, the process proceeds to Step S807.

### (Step 806)

The matching coincidence calculation portion 104 determines whether ID[prev] is included in USED. If it determines that ID[prev] is not included in USED, the matching coincidence calculation portion 104 increases the value of SCORE by 1, adds ID[prev] to USED, and also adds the correspondence relation “ID[rule]:ID[prev]” to MAP. After Step S806, the process proceeds to Step S807.

### (Step S807)

The matching coincidence calculation portion 104 performs the termination of loop L81. Specifically, the matching coincidence calculation portion 104 determines whether or not the processing of loop L81 has been performed for all the correspondences “ID[rule]:ID[prev]” contained in the application location M[prev]. If it is determined that there is a correspondence “D[rule]:ID[prev]” for which the processing of loop L81 has not been performed, the matching coincidence calculation portion 104 returns to Step S803 and continues processing loop L81 for the outstanding correspondence “ID[rule]:ID[prev]”. On the other hand, if it is determined that the processing of loop L81 has been performed for all the correspondences “ID[rule]:ID[prev]”, the matching coincidence calculation portion 104 terminates loop L81. After completion of the loop L81, the process proceeds to Step S808.

### (Step S808)

The matching coincidence calculation portion 104 sets SCORE again to the value obtained by dividing SCORE by the number N of nodes included in the right-hand side of the embodiment rule R[new], and then outputs the obtained value of SCORE as the similarity score and the value of MAP as the new identifier mapping. The similarity score calculated by the matching coincidence calculation portion 104 is an example of the first evaluation value. The matching coincidence calculation portion 104 is an example of an embodiment rule application evaluation means. After Step S808, the matching coincidence calculation portion 104 terminates the process in FIG. 8.

The above is a description of the operation of the matching coincidence calculation portion 104.

The following are four examples of the operation of the matching coincidence calculation portion 104. In the following four examples, the embodiment rules shall be those described in FIG. 4, and the following embodiment action a[prev] shall be used in common for all primary embodiment actions.
(a[prev]) embodiment rule APP-HOST, application location {{1}:App1, {2}: Machine2}

(Example 1) Let us consider the embodiment action a[new] as “embodiment rule APP-HOST, applicable location {{1}:App1, {2}:Machine1}”, with the prohibited identifier list “App1, Machine1, Machine2”. In this case, the correspondence with respect to all two identifiers in the left-hand side of the embodiment rule APP-HOST is included in the application of the embodiment action a[new], and only one correspondence destination matches. Therefore, the matching coincidence calculation portion 104 calculates the similarity score as ½=0.5. In addition, the matching coincidence calculation portion 104 outputs the empty identifier allocation information, which is the initial value, as it is, as the new identifier mapping.

(Example 2) Let us consider the embodiment action a[new] as “embodiment rule APP-HOST, applicable location {{1}:App1, {2}:Machine2}”, with the prohibited identifier list “App1, Machine1, Machine2”. In this case, the correspondence with respect to all two identifiers in the left-hand side of the embodiment rule APP-HOST is included in the application location of the embodiment action a[new], and both correspondence destinations match. Therefore, the matching coincidence calculation portion 104 calculates the similarity score as 2/2=1. In addition, the matching coincidence calculation portion 104 outputs the empty identifier allocation information, which is the initial value, as it is, as the new identifier mapping.

(Example 3) Let us consider the embodiment action a[new] as “embodiment rule APP-HOST, application location {{1}:App1”, with the prohibited identifier list “App1, Machine1”. In this case, the correspondence with respect to the identifiers {2} included in the left-hand side of the embodiment rule APP-HOST is not included in the application location of the embodiment action a[new], nor in the list of prohibited identifiers. Therefore, the matching coincidence calculation portion 104 calculates the similarity score as 2/2=1. The matching coincidence calculation portion 104 also calculates the new identifier mapping as “{2}:Machine2”.

(Example 4) Let us consider the embodiment action a[new] as “embodiment rule APP-HOST, application location {{1}:App1}”, with the prohibited identifier list “App1, Machine1, Machine2”. In this case, the correspondence with respect to the identifiers {2} included in the left-hand side of the embodiment rule APP-HOST is not included in the application location of the embodiment action a[new], while it is included in the list of prohibited identifiers. Therefore, the matching coincidence calculation portion 104 calculates the similarity score as ½=0.5. In addition, the matching coincidence calculation portion 104 outputs the empty identifier allocation information, which is the initial value, as it is, as the new identifier mapping.

The above is an illustration of the operation of the matching coincidence calculation portion 104.

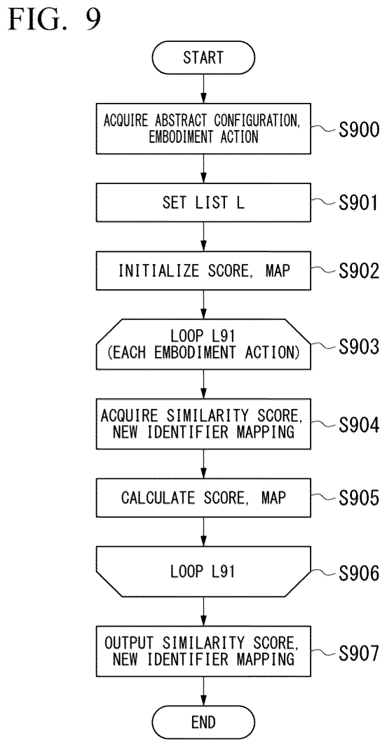

The operation of the similarity calculation portion 103 shall be described next. FIG. 9 is a flowchart showing an example of the operation of the similarity calculation portion 103.

### (Step S900)

The similarity calculation portion 103 receives as input the abstract configuration D and the embodiment action a[new] applicable to the abstract configuration D. After Step S900, the process proceeds to Step S901.

### (Step S901)

The similarity calculation portion 103 generates a list L from which the identifiers of all nodes used in the abstract configuration D are extracted. After Step S901, the process proceeds to Step S902.

### (Step S902)

The similarity calculation portion 103 sets the initial value of SCORE to 0 and further sets the initial value of MAP to the empty identifier assignment information. After Step S902, the process proceeds to Step S903.

### (Step S903)

The similarity calculation portion 103 executes loop L91, which performs a process for each embodiment action a[i] included in the primary design history a[1], a[2], . . . , a[n] received as input by the system configuration derivation device 100. After Step S903, the process proceeds to Step S904.

### (Step S904)

The similarity calculation portion 103 inputs a[new] as a new embodiment action, a[i] as a primary embodiment action, and L as a list of prohibited identifiers to the matching coincidence calculation portion 104, and obtains as output the similarity SCORE[i] between the new embodiment action a[new] and the primary embodiment action a[i] and the new identifier mapping MAP[i]. After Step S904, the process proceeds to Step S905.

### (Step S905)

The similarity calculation portion 103 compares SCORE[i] and SCORE, and if SCORE[i] is larger, updates SCORE to SCORE[i] and MAP to MAP[i], respectively. After Step S905, the process proceeds to Step S906.

### (Step S906)

The similarity calculation portion 103 performs the termination of loop L91. Specifically, the similarity calculation portion 103 determines whether the processing of the loop L91 has been performed for all the embodiment actions a[i] included in the primary design history a[1], a[2], . . . , a[n]. If it is determined that there is an embodiment action a[i] for which loop L91 has not been processed, the similarity calculation portion 103 returns to Step S903 and continues processing loop L91 for the unprocessed embodiment action a[i]. On the other hand, if it is determined that loop L91 has been performed for all embodiment actions a[i], the similarity calculation portion 103 terminates the loop L91. After completion of the loop L91, the process proceeds to Step S907.

### (Step S907)

The similarity calculation portion 103 outputs the similarity score SCORE and the new identifier mapping MAP. After Step S907, the similarity calculation portion 103 terminates the process shown in FIG. 9.

The similarity calculation portion 103 returns the value of the similarity score that is the highest (i.e., the most similar score being the highest one) among the embodiment actions included in the primary design history to the input embodiment action.

The above is a description of the operation of the similarity calculation portion 103.

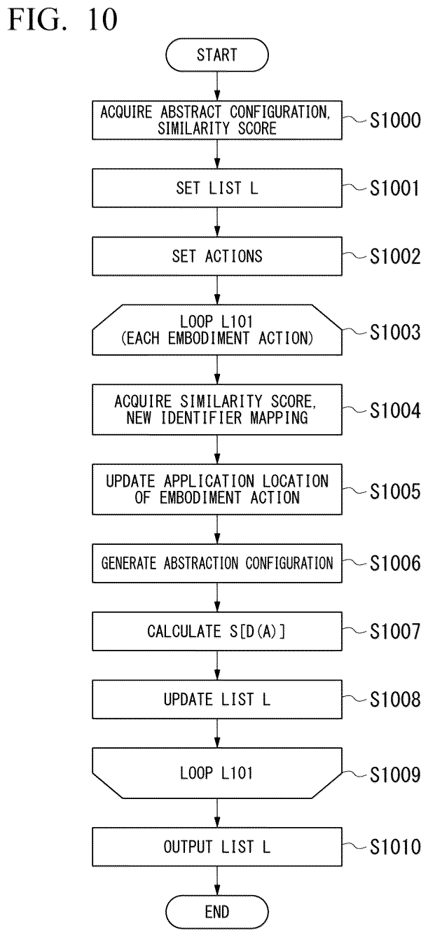

The operation in which the embodiment application/similarity reflection portion 102 generates a list of candidate embodiments is explained with reference to the drawings. FIG. 10 is a flowchart showing an example of the procedure in which the embodiment application/similarity reflection portion 102 generates a list of candidate embodiments.

### (Step S1000)

The embodiment application/similarity reflection portion 102 receives as input the abstract configuration D and the similarity score S[D]. After Step S1000, the process proceeds to Step S1001.

### (Step S1001)

The embodiment application/similarity reflection portion 102 initializes the resulting list of candidates L to be output as an empty list. After Step S1001, the process proceeds to Step S1002.

### (Step S1002)

The embodiment application/similarity reflection portion 102 generates all embodiment actions that can be applied to the abstract configuration D based on the list of available embodiment rules read by the system configuration derivation unit 100 as preprocessing, and composes an embodiment action list Actions. If multiple embodiment actions are possible for the same embodiment rule, as illustrated in FIG. 5, all possible embodiment actions may be included in the list Actions, but it is not limited thereto. After Step S1002, the process proceeds to Step S1003.

### (Step S1003)

The embodiment application/similarity reflection portion 102 executes loop L101, which processes all embodiment actions a in the list Actions. After Step S1003, the process proceeds to Step S1004.

### (Step S1004)

The embodiment application/similarity reflection portion 102 inputs the abstract configuration D and the embodiment action a to the similarity calculation portion 103 to obtain its output, the similarity score S[a] and the new identifier mapping MAP. After Step S1004, the process proceeds to Step S1005.

### (Step S1005)

The embodiment application/similarity reflection portion 102 adds all correspondences included in the new identifier mapping MAP obtained in Step S1004 to the application location of embodiment action a. After Step S1005, the process proceeds to Step S1006.

### (Step S1006)

The embodiment application/similarity reflection portion 102 generates a new abstract configuration D(a) by rewriting the abstract configuration D with the embodiment action a.

The data of the original abstract configuration D itself shall not be rewritten by the rewriting of the abstract configuration in Step S1006. In other words, in Step S1006, the new abstract configuration D(a), which is generated by rewriting by the embodiment action, is newly generated as data separate from the abstract configuration D. After Step S1006, the process proceeds to Step S1007.

### (Step S1007)

The embodiment application/similarity reflection portion 102 calculates the similarity score S[D(a)] for the abstract configuration D(a) using the similarity score S[D] of the abstract configuration D and the similarity score S[a] obtained in Step S1004, by means of the following score update formula Sc.

$$( Score update formula Sc ) S [ D ( a ) ] = w 1 \times S [ D ] + w 2 \times S [ a ] ( where w 1 and w 2 are positive constants )$$

w1 and w2 are weight constants that determine how much the original similarity score S[D] and the newly applied embodiment action score S[a] are reflected in the similarity score of the abstract configuration D(a), respectively. For example, w1=w2=1 is a simple cumulative sum. Alternatively, setting w1=0.5, w2=1 would result in taking the value of the sum of the scores of the old embodiment actions added together with attenuation by ½ each. The weights may take any value as long as it is a positive constant value. The similarity score S[D(a)] for the abstract configuration, calculated by the embodiment application/similarity reflection portion 102, corresponds to an example of the second evaluation value. The combination of the configuration information embodiment portion 101 and the embodiment application/similarity reflection portion 102 corresponds to an example of an embodiment means. After Step S1007, the process proceeds to Step S1008.

### (Step S1008)

The embodiment application/similarity reflection portion 102 adds the pair (D[a], S[D(a)]) to the list L. After Step S1008, the process proceeds to Step S1009.

### (Step S1009)

The embodiment application/similarity reflection portion 102 performs the termination of loop L101. Specifically, the embodiment application/similarity reflection portion 102 determines whether or not the processing of loop L101 has been performed for all embodiment actions included in Actions. If it is determined that there is an embodiment action for which the processing of loop L91 has not been performed, the embodiment application/similarity reflection portion 102 returns to Step S1003 and continues the processing of loop L101 for the unprocessed embodiment action. On the other hand, if it is determined that the processing of loop L101 has been performed for all embodiment actions, the embodiment application/similarity reflection portion 102 terminates loop L101. After completion of loop L101, the process proceeds to Step S1010.

### (Step S1010)

The embodiment application/similarity reflection portion 102 returns a list L as output. After Step S1010, the embodiment application/similarity reflection portion 102 ends the process in FIG. 10.

The above is a description of the operation of the embodiment application/similarity reflection portion 102.

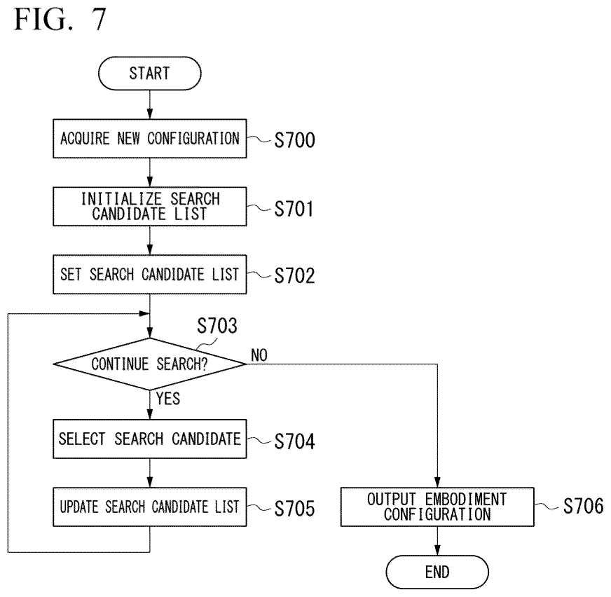

The operation of the configuration information embodiment portion 101 designing the ICT system shall be described with reference to the drawings. FIG. 7 is a flowchart showing an example of the procedure in which the configuration information embodiment portion 101 derives the embodiment configuration of the system.

### (Step S700)

The configuration information embodiment portion 101 receives as input a new requirement D_init expressed in the form of an abstract configuration from an input/output device. The input/output device is a device that serves as an interface between the system configuration derivation device 100 and the outside world. After Step S700, the process proceeds to Step S701.

### (Step S701)

The configuration information embodiment portion 101 initializes a search candidate list T to an empty list. After Step S701, the process proceeds to Step S702.

### (Step S702)

In the configuration information embodiment portion 101, added to the search candidate list T are two pairs, such that the first element is the abstract configuration and the second element is the similarity score value thereof. The configuration information embodiment portion 101 adds the pair (D_init, 0) to the search candidate list T. After Step S702, the process proceeds to Step S703.

### (Step S703)

The configuration information embodiment portion 101 determines whether or not to continue the tree search. Specifically, the configuration information embodiment portion 101 determines whether a sufficient number of embodiment configurations have not been added to the search candidate list T and whether the abstract configuration to be searched is missing from the search tree. The threshold value here, “a (sufficient) number of pieces”, is specified, for example, by using a value entered through an input/output device or as a value that is built into the device from the beginning.

If the configuration information embodiment portion 101 determines that a sufficient number of embodiment configurations have not been added to the search candidate list T and that the abstract configuration to be searched for is not missing from the search tree (Step S703: YES), the process proceeds to Step S704. On the other hand, if the configuration information embodiment portion 101 determines that a sufficient number of embodiment configurations have been added to the search candidate list T or that there are no more abstract configurations to search in the search tree (Step S703: NO), the process proceeds to Step S706.

### (Step S704)

The configuration information embodiment portion 101 selects one of the pairs (D, S) included in the search candidate list T that satisfies all of the following three conditions (c31), (c32), and (c33).
(c31) Abstract configuration D is not fully embodied.
(c32) No pair with the same first element as abstract configuration D has been previously selected in Step S704.
(c33) Similarity score S is the highest among the similarity scores of the pairs in the search candidate list T.

After Step S704, the process proceeds to Step S705.

### (Step S705)

The configuration information embodiment portion 101 inputs the abstract configuration D and similarity score S selected in Step S704 to the embodiment application/similarity reflection portion 102 to obtain the output, a list of abstract configuration and similarity score pairs. Then, the configuration information embodiment portion 101 adds all the pairs included in the list to the search candidate list T. After Step S705, the process returns to Step S703.

### (Step S706)

The configuration information embodiment portion 101 outputs the resulting embodiment configuration to an input/output device as the result of the system configuration derivation device 100. The configuration information embodiment portion 101 may output the embodiment configuration in association with the similarity score for that embodiment configuration. After Step S706, the configuration information embodiment portion 101 terminates the process in FIG. 7.

The above is a description of the operation of the configuration information embodiment portion 101.

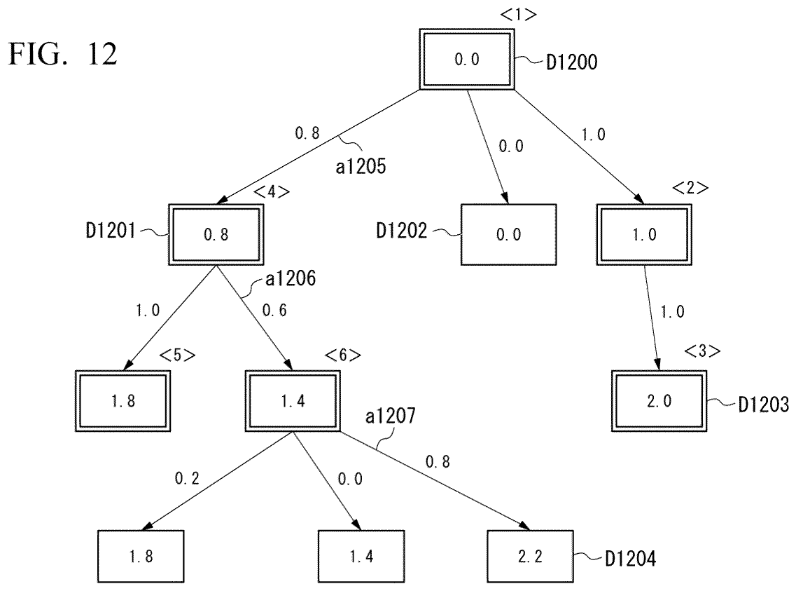

The operation of the configuration Information embodiment portion 101 shall be explained here using an example. FIG. 12 shows an example of a tree explored by the configuration information embodiment portion 101. The example in FIG. 12 assumes the behavior of the embodiment application/similarity reflection portion 102, which calculates the similarity score of the (post-embodiment) abstract configuration as a simple sum of the similarity score of the abstract configuration to be embodied and the similarity score of the embodiment configuration.

The rectangles with single or double lined borders around numerical values, shown in FIG. 12, represent pairs consisting of abstract configurations and similarity scores that have been added to the search candidate list T. In FIG. 12, abstract configurations are omitted and similarity scores are indicated by the numbers in the rectangles. In the description of FIG. 12, the pair consisting of an abstract configuration and a similarity score will be referred to as the “search state” for convenience.

The rectangle with a single-line border represents the search state that was not selected in Step S704. The rectangle with a double-line border represents the search state selected in Step S704. In addition, in the upper right corner of each rectangle with a double-line border are numbers surrounded by “<” and “>”. The number indicates how many times the search state indicated by that rectangle was selected in Step S704.

The topmost search state D1200 in FIG. 12 is the search state corresponding to the new requirement given as input, and is added to the search candidate list T in Step S702 of FIG. 7.

The arrows illustrated in FIG. 12, extending from square to square, can correspond to the loop portion of the flowchart shown in FIG. 7, and represent the process in Step S705 in a case where the search state corresponding to the starting point of the arrow in question is selected in Step S704. Specifically, an arrow indicates that in this case, the configuration information embodiment portion 101 generated the search state corresponding to the end point of that arrow in Step S705. In the explanation of FIG. 12, this arrow will also be referred to as a “transition” for convenience.

In addition, each transition (each arrow) is marked with a numerical value. This number indicates the similarity score of the embodiment action corresponding to the transition. Here, the embodiment application/similarity reflection portion 102 generates exactly one transition (in a one-to-one correspondence) corresponding to the embodiment action that can be applied to the starting point search state (the abstract configuration contained therein). The number attached to each transition indicates the similarity score of the embodiment action that will be mapped to the transition in this generation.

As shown in FIG. 12, the configuration information embodiment portion 101 selects the search state with the highest similarity score among the search states that exist at the stage of performing Step S704 in FIG. 7. For example, immediately after selecting search state D1200, the configuration information embodiment portion 101 has the following similarity scores for the search states added to the search candidate list T: search state D1201 with a similarity score of 0.8, search state D1202 with a similarity score of 0.0, and search state D1203 with a similarity score of 2.0. The configuration information embodiment portion 101 next selects the search state D1203, which has the highest similarity among these search states.

As shown in FIG. 12, the similarity score attached to each state is the sum of the similarity scores of the previously applied embodiment actions. For example, search state D1204 is obtained by applying embodiment actions a1205, a1206, and a1207 to search state D1200. Search state D1204 has a similarity score of 2.2, which is the sum of the similarity score of 0.8 that embodiment action a1205 has, the similarity score of 0.6 that embodiment action a1206 has, and the similarity score of 0.8 that embodiment action a1207 has.

The above is a description of an example of the operation of the configuration information embodiment portion 101.

As shown in the example in FIG. 12, the configuration information embodiment portion 101 exhibits the behavior of preferentially proceeding with the search from the search state obtained by applying as many embodiment actions similar to those used in the primary design history as possible. As a result, the embodiment configuration resulting from this tree search is designed by the same embodiment procedure as the primary design history, and therefore, the result is similar to the primary embodiment configuration.

### Explanation of Effects

The configuration information embodiment portion 101 of the system configuration derivation device 100 receives new requirements and information corresponding to the procedure for designing primary requirements similar to the new requirements (primary design history), and repeatedly embodies such new requirements by applying the embodiment rules. The configuration information embodiment portion 101 performs tree search on a tree with new requirements as roots and abstract configurations as nodes, and finally outputs the configuration information (embodiment configuration) of a fully concretized ICT system.

In addition, the configuration information embodiment portion 101 queries the embodiment application/similarity reflection portion 102 at each branch of the tree search, and ties information on the similarity score, which indicates “how much embodiment similar to the given primary design history has been applied or not” to each branch destination.

In addition, the configuration information embodiment portion 101 proceeds with the search preferentially from those with high similarity scores.

In the system configuration derivation device 100, embodiment can be prioritized from abstract configurations with similar embodiments in the primary design history, allowing the output of configuration information for a fully embodied ICT system that is similar to the ICT system obtained as the primary embodiment configuration.

As described above, the matching coincidence calculation portion 104 calculates a similarity score indicating the evaluation of the similarity between the embodiment actions included in the design history and the candidate embodiment actions for the new design. The combination of the configuration information embodiment portion 101 and the embodiment application/similarity reflection portion 102 selects, among the abstract configurations obtained by applying the embodiment action to the new configuration one or more times, an abstract configuration and repeats the embodiment rule application for the selected abstract configuration, wherein the abstract configuration is selected on the basis of a similarity score for abstract configurations that is calculated on the basis of a similarity score and indicates the evaluation of the similarity of the overall application of one or more of the embodiment actions until the abstract configuration is obtained from the new configuration to the application of one or more embodiment actions included in the design history.

According to the system configuration derivation device 100, it is expected that the embodiment configuration relatively close to the embodiment configuration shown in the design history can be obtained, in that the abstract configuration is selected on the basis of the similarity to the abstract configuration calculated by the embodiment application/similarity reflection portion. According to the system configuration derivation device 100, it is expected to obtain an embodiment configuration that is relatively close to the embodiment configuration designed in the past as shown in the design history, and in this respect, it is expected to obtain a relatively reliable system.

The matching coincidence calculation portion 104 calculates a similarity score based on whether the embodiment rules applied are the same between the embodiment actions included in the design history and the candidate embodiment actions included in the iterations of applying embodiment actions to new configurations, and how well the system sub-configurations to which the embodiment rules are applied match each other.

According to the system configuration derivation device 100, it is expected to obtain embodiment configurations that are closer to those contained in the design history in terms of evaluating similarity based on both the embodiment rules and the application locations.

The combination of the configuration information embodiment portion 101 and the embodiment application/similarity reflection portion 102 manages each abstract configuration obtained by applying the embodiment rule to the new configuration and abstract configuration one or more times by linking them with a similarity score to the abstract configuration, preferentially selects an abstract configuration the higher the similarity indicated by a similarity score for the abstract configuration, and repeats application of the embodiment rule to the selected abstract configuration.

According to the system configuration derivation device 100, it is expected to obtain an embodiment configuration that is relatively close to the embodiment configuration included in the design history.

### Second Example Embodiment

### (Description of Configuration)

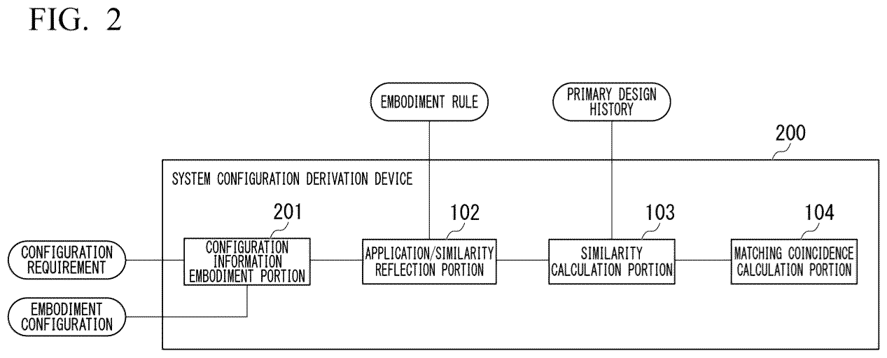

FIG. 2 is a block diagram showing an example configuration of a system configuration derivation device 200 according to the second example embodiment. In the configuration shown in FIG. 2, the system configuration derivation device 100 is provided with a configuration information embodiment portion 201, an embodiment application/similarity reflection portion 102, a similarity calculation portion 103, and a matching coincidence calculation portion 104. Those parts of FIG. 2 that have similar functions corresponding to the parts in FIG. 1 are marked with the same reference numerals (102, 103, 104) and are omitted here from detailed explanation.

The system configuration derivation device 200 is provided with a configuration information embodiment portion 201 instead of the configuration information embodiment portion 101 of the system configuration derivation device 100.

Except for the points mentioned above, the configuration of the system configuration derivation device 200 is similar to that of the system configuration derivation device 100.

### (Explanation of Operation)

The embodiment application/similarity reflection portion 102, similarity calculation portion 103, and matching coincidence calculation portion 104 of the system configuration derivation device 200 are the same as for the system configuration derivation device 100.

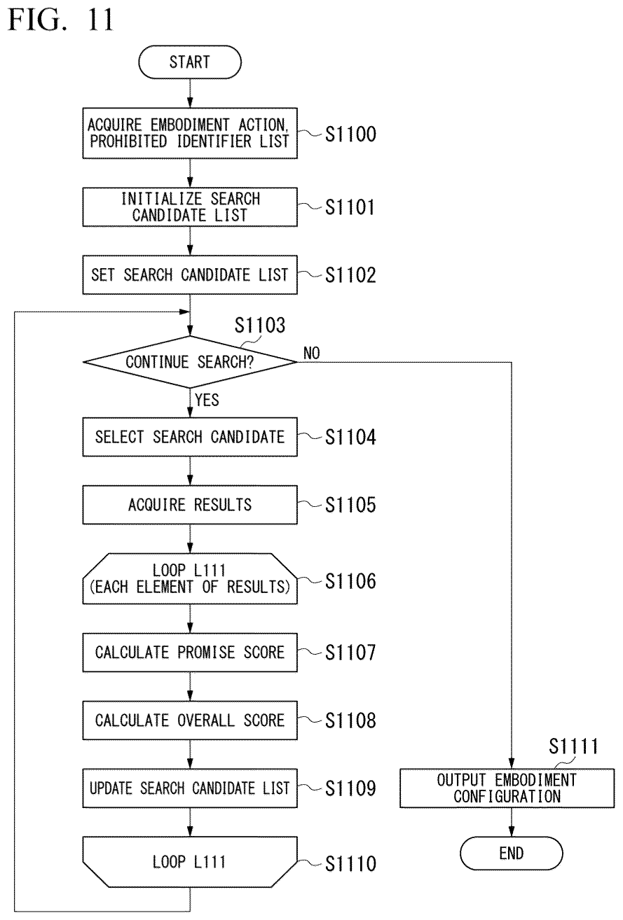

FIG. 11 is a flowchart showing an example of the operation of the configuration information embodiment portion 201. In the second example embodiment, the case in which the configuration information embodiment portion 201 designs an ICT system will be used as an example. However, the system to be designed by the configuration information embodiment portion 201 is not limited to any particular system.

### (Step S1100)

The configuration information embodiment portion 201 receives as input the configuration requirement D_init expressed in the form of an abstract configuration from input/output devices. After Step S1100, the process proceeds to Step S1101. The configuration requirement D_init is referred to as a new requirement.

### (Step S1101)

The configuration information embodiment portion 201 initializes the search candidate list T to an empty list. After Step S1100, the process proceeds to Step S1102.

### (Step S1102)

In the configuration information embodiment portion 201, added to the search candidate list T are sets of three such that the first element is the abstract configuration, the second element is the value of the similarity score thereof, and the third element is the value of the overall score.

The configuration information embodiment portion 201 adds the set of three (D_init, 0, 0) to the search candidate list T. After Step S1102, the process proceeds to Step S1103.

### (Step S1103)

The configuration information embodiment portion 201 determines whether or not to continue the tree search. Specifically, the configuration information embodiment portion 201 determines whether a sufficient number of embodiment configurations have not been added to the search candidate list T and whether the abstract configuration to be searched is missing from the search tree. The threshold value here, “a (sufficient) number of pieces”, is specified, for example, by using a value entered through an input/output device or as a value that is built into the device from the beginning.

If the configuration information embodiment portion 201 determines that a sufficient number of embodiment configurations have not been added to the search candidate list T and that the abstract configuration to be searched for is not missing from the search tree (Step S1103: YES), the process proceeds to Step S1104. On the other hand, if the configuration information embodiment portion 101 determines that a sufficient number of embodiment configurations have been added to the search candidate list T or that there are no more abstract configurations to search in the search tree (Step S1103: NO), the process proceeds to Step S1111.

### (Step S1104)

The configuration information embodiment portion 201 selects one of the sets (D, Ss, Si) included in the search candidate list T that satisfies all of the following three conditions (c41), (c42), and (c43).
(c41) Abstract configuration D is not fully embodied.
(c42) No set with the same first element as abstract configuration D has been previously selected in Step S1104.
(c43) The score Si is the highest overall score of the sets included in the search candidate list T.

After Step S1104, the process proceeds to Step S1105.

### (Step S1105)

The configuration information embodiment portion 201 inputs the abstract configuration D and similarity score Ss selected in Step S1104 to the embodiment application/similarity reflection portion 102 to obtain the output, a list Results of sets of abstract configurations and similarity scores. After Step S1105, the process proceeds to Step S1106.

### (Step S1106)

The configuration information embodiment portion 201 executes a loop L111 that processes each two-element set (D′, Ss′) included in the list Results. After Step S1106, the process proceeds to Step S1107.

### (Step S1107)

The configuration information embodiment portion 201 calculates a promise score Sp′ based on the abstract configuration D′. Here, the abstract configuration's promise score is a calculation of the probability that the abstract configuration can be traced to an embodiment configuration. There is no limit to the specific indicators that the configuration information embodiment portion 201 will employ for the promise score.

For the abstract configuration's promise score, for example, the number N of abstract components that the abstract configuration contains, i.e., the number of elements to be eliminated by embodiment, may be counted, and the reciprocal of that number, 1/N, may be used as the promise score. This is based on the consideration that the fewer the number of elements to be eliminated by the concretization process, the faster one will arrive at an embodiment configuration.

Alternatively, a promise score for the abstract configuration may be determined using the method described in Japanese Patent Publication No. 6989014 (or a similar method), as a value representing the promisingness of the abstract configuration.

However, the methods by which the configuration information embodiment portion 201 determines the promise score are not limited thereto. After Step S1107, the process proceeds to Step S1108.

### (Step S1108)

The configuration information embodiment portion 201 calculates the overall score Si′ based on the promise score Sp′ and the similarity score Ss' of the abstract configuration D′. The specific method by which the configuration information embodiment portion 201 calculates the overall score Si′ is not limited to any particular method.

For example, in Step S1108, the configuration information embodiment portion 201 may calculate the overall score Si′ by the simple sum Si′=Sp′+Ss′.

Alternatively, in Step S1108, the configuration information embodiment portion 201 may calculate the overall score Si′ by the weighted sum Si′=w1×Sp′+w2×Ss′. In addition, the weights w1 and w2 can be set to a value @ that is not a real number but represents some kind of “infinity” that is guaranteed to be absolutely large with respect to Sp′ and Ss′. This means that, for example, if w1-ω, w2=1, it is possible to realize the behavior in which the magnitude of the value of Si′ is determined by the value of Sp′ if there is a difference between the large and small values of Sp′, and by the value of Ss' if there is no difference between the large and small values of Sp′.

However, the method by which the configuration information embodiment portion 201 determines the overall score is not limited thereto. The overall score corresponds to an example of a third evaluation value. The combination of the configuration information embodiment portion 201 and the embodiment application/similarity reflection portion 102 is an example of an embodiment means. After Step S1108, the process proceeds to Step S1109.

### (Step S1109)

The configuration information embodiment portion 201 adds the three-element set (D′, Ss′, Si′) to the search candidate list T. After Step S1109, the process proceeds to Step S1110.

### (Step S1110)

The configuration information embodiment portion 201 performs the termination of loop L111. Specifically, the configuration information embodiment portion 201 determines whether or not loop L111 has been processed for all two-element sets (D′, Ss′) in the list Results. If it is determined that there are two-element sets (D′, Ss′) for which the processing of loop L111 has not been performed, the configuration information embodiment portion 201 returns to Step S1106 and continues to perform the processing of loop L111 for the unprocessed two-element sets (D′, Ss′). On the other hand, if it is determined that the processing of loop L111 has been performed for all two-element sets (D′, Ss′), the configuration information embodiment portion 201 terminates loop L111. After the completion of loop L111, the process returns to Step S1103.

### (Step S1111)

The configuration information embodiment portion 201 outputs the resulting embodiment configuration to input/output devices as the result of the system configuration derivation device 200. The configuration information embodiment portion 201 may be configured to output the embodiment configuration in association with the overall score, promise score, or similarity score for that embodiment configuration, or a combination of these scores. After Step S1111, the system configuration derivation device 200 terminates the process shown in FIG. 11.

For efficient execution of Step S1104, the system configuration derivation device 200 may maintain a data structure called used that manages a list of “abstract configurations included in the search candidate list T that have been previously selected in this step”. For example, the configuration information embodiment portion 201, upon selecting the two-element set (D, S) in Step S1104, adds D to the used list. Furthermore, in Step S1109, the configuration information embodiment portion 201 does not add to T if the first element of the set to be added is already included in used. This eliminates the need for the configuration information embodiment portion 201 to check the condition (c42) in Step S1104.

For efficient execution of Step S1104, the search candidate list T can be implemented not as a simple list but as a prioritized queue (i.e., a data structure that enables efficient “pop operation” to retrieve the largest element among the included elements in terms of size). In such a case, the order relationship between sets is assumed to be defined simply by the size of the similarity score, ignoring the abstract structure. As a result, in Step S1104, elements satisfying the condition (C43) can be retrieved simply by performing a pop operation on T.

However, the method of executing step S1104 is not limited to these methods.

The above is a description of the operation of the configuration information embodiment portion 201.

### (Explanation of Effects)

The configuration information embodiment portion 201 differs from the configuration information embodiment portion 101 in that the abstract configuration to be prioritized for embodiment is determined not only by the similarity score, but also by the value obtained by adding the promise score to the similarity score.

The configuration information embodiment portion 101, which determines the abstract configuration to be preferentially embodied based on the similarity score, is expected to quickly obtain a configuration that is close to the primary embodiment configuration, as described above. On the other hand, if, for some reason, the primary design history (due to the difference between new and primary requirements) turns out to be the incorrect approach as the embodiment procedure for new requirements, a considerable number of search steps may be required to arrive at an embodiment configuration.

According to the configuration information embodiment portion 201, a tree search can be controlled by an index that takes into account not only the similarity score but also the promise score, which indicates the ease of completing the embodiment. Accordingly, even if, as described above, the primary design history is the wrong approach as the embodiment procedure for a new requirement, it is expected that the embodiment configuration can be obtained in a relatively short time. According to the system configuration derivation device 200, it is expected that a reduction in search efficiency can be mitigated in this respect.

As described above, the combination of the configuration information embodiment portion 201 and the embodiment application/similarity reflection portion 102 selects an abstract configuration based on a similarity score for the abstract configuration, as well as a promise score that indicates the probability of obtaining an embodiment configuration from that abstract configuration by repeatedly applying embodiment rules to the abstract configuration.

According to the system configuration derivation device 200, even if the primary design is the wrong approach as the embodiment procedure for a new requirement, it is expected that the embodiment configuration can be obtained in a relatively short time.

### Third Example Embodiment

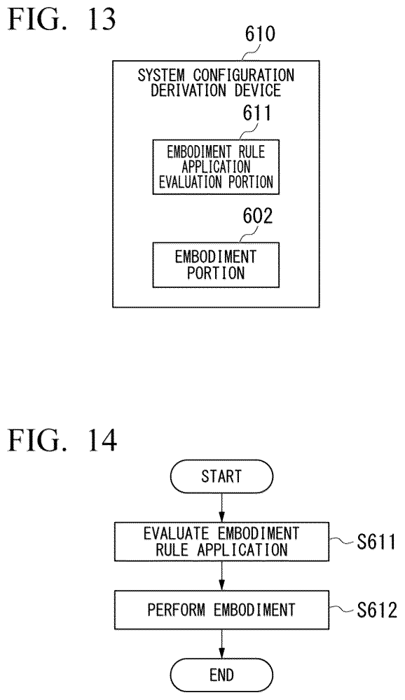

FIG. 13 is a drawing showing an example of the configuration of the system configuration derivation device according to the third example embodiment. In the configuration shown in FIG. 13, a system configuration derivation device 610 is provided with an embodiment rule application evaluation portion 611 and an embodiment portion 612.

The embodiment rule application evaluation portion 611 in such a configuration calculates a first evaluation value indicating an evaluation of the similarity between a specific embodiment rule application included in a design history showing the history of in a case where an embodiment configuration, which is a system configuration not including an abstract element, is obtained by repeatedly applying an embodiment rule to an abstract configuration, which is a system configuration including an abstract element, and a candidate of the embodiment rule application that is used for a new configuration, which is the abstract configuration of a system design target, in a case where determining the embodiment configuration.

The embodiment portion 612 selects, among abstract configurations obtained by applying the embodiment rule to the new configuration one or more times, a specific abstract configuration and repeats the embodiment rule application for the selected specific abstract configuration, wherein the specific abstract configuration is selected on the basis of a second evaluation value that is calculated on the basis of the first evaluation value and indicates the evaluation of the similarity, with the design history, of the entirety of one or more applications of the embodiment rule until the abstract configuration is obtained from the new configuration. The embodiment rule application evaluation portion 611 corresponds to an example of an embodiment rule application evaluation means. The embodiment portion 612 corresponds to an example of an embodiment means.

According to the system configuration derivation device 610, it is expected that the embodiment configuration relatively close to the embodiment configuration shown in the design history can be obtained, in that the abstract configuration is selected on the basis of the second evaluation value. According to the system configuration derivation device 610, it is expected that an embodiment configuration that is relatively close to the embodiment configuration designed in the past as shown in the design history can be obtained, and in this respect, it is expected that a relatively reliable system can be obtained.

### Fourth Example Embodiment

FIG. 14 is a drawing showing an example of the processing steps in the system configuration derivation method according to the fourth example embodiment. The system configuration derivation method shown in FIG. 14 includes evaluating the embodiment rule application (Step S611) and performing embodiment (Step S612).

In evaluating an embodiment rule application (Step 611), a computer calculates a first evaluation value indicating an evaluation of the similarity between a specific embodiment rule application included in a design history showing the history of in a case where an embodiment configuration, which is a system configuration not including an abstract element, is obtained by repeatedly applying an embodiment rule to an abstract configuration, which is a system configuration including an abstract element, and a candidate of the embodiment rule application that is used for a new configuration, which is the abstract configuration of a system design target, in a case where determining the embodiment configuration.

In performing embodiment (Step S612), a computer selects, among abstract configurations obtained by applying the embodiment rule to the new configuration one or more times, a specific abstract configuration and repeats the embodiment rule application for the selected specific abstract configuration, wherein the specific abstract configuration is selected on the basis of a second evaluation value that is calculated on the basis of the first evaluation value and indicates the evaluation of the similarity, with the design history, of the entirety of one or more applications of the embodiment rule until the abstract configuration is obtained from the new configuration.

According to the system configuration derivation method shown in FIG. 14, it is expected that the processing configuration of selecting an abstract configuration based on the second evaluation value will result in an embodiment configuration that is relatively close to the embodiment configuration shown in the design history. According to the system configuration derivation method shown in FIG. 14, it is expected that an embodiment configuration that is relatively close to the embodiment configuration designed in the past as shown in the design history can be obtained, and so in this respect, it is expected that a relatively reliable system can be obtained.

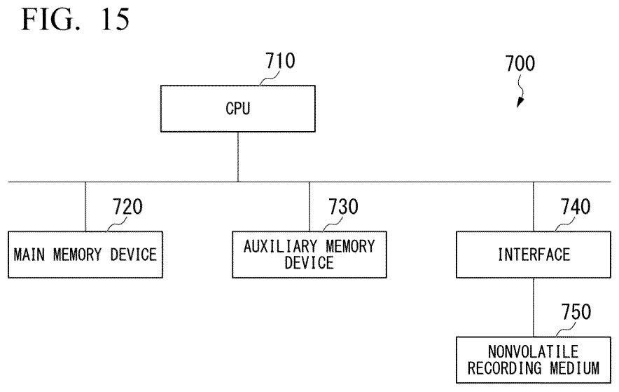

FIG. 15 is a schematic block diagram showing the configuration of a computer in accordance with at least one example embodiment. In the configuration shown in FIG. 15, a computer 700 is provided with a CPU 710, a main memory device 720, an auxiliary memory device 730, an interface 740, and a nonvolatile recording medium 750.

Any one or more of the system configuration derivation device 100, the system configuration derivation device 200, and the system configuration derivation device 610 described above, or any part thereof, may be implemented in the computer 700. In that case, the operations of each of the above-mentioned processing portions are stored in the auxiliary memory device 730 in the form of a program. The CPU 710 reads the program from the auxiliary memory device 730, deploys it in the main memory device 720, and executes the above processing according to the program. The CPU 710 also reserves a memory area in the main memory device 720 corresponding to each of the above-mentioned memory portions according to the program. Communication between each device and other devices is performed by the interface 740, which has a communication function and communicates according to the control of the CPU 710. The interface 740 also has a port for the nonvolatile recording medium 750 and reads information from and writes information to nonvolatile recording medium 750.

In a case where the system configuration derivation device 100 is implemented in the computer 700, the operations of the configuration information embodiment portion 101, the embodiment application/similarity reflection portion 102, the similarity calculation portion 103, and the matching coincidence calculation portion 104 are stored in the auxiliary memory device 730 in program form. The CPU 710 reads the program from the auxiliary memory device 730, deploys it in the main memory device 720, and executes the above processing according to the program.

The CPU 710 also allocates a storage area in the main memory device 720 for the system configuration derivation device 100 to perform processing according to the program. Communication between the system configuration derivation device 100 and other devices is performed by the interface 740, which has communication functions and operates according to the control of the CPU 710. The interaction between the system configuration derivation device 100 and the user is performed by the interface 740 having input and output devices, presenting information to the user with the output devices and receiving user operations with the input devices according to the control of the CPU 710.

In a case where the system configuration derivation device 200 is implemented in the computer 700, the operations of the configuration information embodiment portion 201, the embodiment application/similarity reflection portion 102, the similarity calculation portion 103, and the matching coincidence calculation portion 104 are stored in the auxiliary memory device 730 in program form. The CPU 710 reads the program from the auxiliary memory device 730, deploys it in the main memory device 720, and executes the above processing according to the program.

The CPU 710 also allocates a storage area in the main memory device 720 for the system configuration derivation device 200 to perform processing according to the program. Communication between the system configuration derivation device 200 and other devices is performed by the interface 740, which has communication functions and operates according to the control of the CPU 710. The interaction between the system configuration derivation device 200 and the user is performed by the interface 740 having input and output devices, presenting information to the user with the output devices and receiving user operations with the input devices according to the control of the CPU 710.

In a case where the system configuration derivation device 610 is implemented in the computer 700, the operations of the embodiment rule application evaluation portion 611 and the embodiment portion 612 are stored in the auxiliary memory device 730 in program form. The CPU 710 reads the program from the auxiliary memory device 730, deploys it in the main memory device 720, and executes the above processing according to the program.

The CPU 710 also allocates a storage area in the main memory device 720 for the system configuration derivation device 610 to perform processing according to the program. Communication between the system configuration derivation device 610 and other devices is performed by the interface 740, which has communication functions and operates according to the control of the CPU 710. The interaction between the system configuration derivation device 610 and the user is performed by the interface 740 having input and output devices, presenting information to the user with the output devices and receiving user operations with the input devices according to the control of the CPU 710.

Any one or more of the above programs may be recorded on the nonvolatile recording medium 750. In this case, the interface 740 may read the program from the nonvolatile recording medium 750. The CPU 710 may then directly execute the program read by the interface 740, or it may be stored once in the main memory device 720 or auxiliary memory device 730 and then subsequently executed.

A program for executing all or part of the processes performed by the system configuration derivation device 100, the system configuration derivation device 200, and the system configuration derivation device 610 may be recorded on a computer-readable recording medium, and the program recorded on this recording medium may be read by a computer system and executed, to perform the processing of each portion. The term “computer system” here shall include hardware such as operating systems and peripherals.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

While the above example embodiments of this invention have been described in detail with reference to the drawings, it should be understood that specific configurations are not limited to these example embodiments, but also include designs, etc., to the extent that they do not depart from the gist of this invention.

### INDUSTRIAL APPLICABILITY

The present invention may be applied to a system configuration derivation device, a system configuration derivation method, and a recording medium.

### DESCRIPTION OF REFERENCE SIGNS

100, 200 System configuration derivation device
101, 201 Configuration information embodiment portion
102 Embodiment application/similarity reflection portion
103 Similarity calculation portion
104 Matching coincidence calculation portion

What is claimed is:

1. A system configuration derivation device comprising:
at least one memory configured to store instructions; and
at least one processor configured to execute the instructions to:
calculate a first evaluation value indicating an evaluation of a similarity between a specific embodiment rule application and a candidate of the embodiment rule application, wherein the specific embodiment rule application is included in a design history, the design history indicates a history of in a case where an embodiment configuration is obtained by repeatedly applying an embodiment rule to an abstract configuration, the embodiment configuration being a system configuration not including an abstract element and the abstract configuration being a system configuration including an abstract element, and the candidate of the embodiment rule application is used for a new configuration in a case where determining the embodiment configuration, the new configuration being the abstract configuration of a system design target;
select, based on a second evaluation value, a specific abstract configuration among the abstract configurations obtained by applying the embodiment rule to the new configuration one or more times, wherein the second evaluation value indicates the evaluation of the similarity with the design history, of the entirety of one or more applications of the embodiment rule until the abstract configuration is obtained from the new configuration; and
repeat the embodiment rule application to the selected specific abstract configuration.

2. The system configuration derivation device according to claim 1, wherein the at least one processor is configured to execute the instructions to calculate the first evaluation value based on whether the embodiment rules applied are the same between the embodiment rule applications included in the design history and the candidates for embodiment rule application included in the repetition of embodiment rule application for the new configuration, and how much the system sub-configurations to which the embodiment rules are applied are the same.

3. The system configuration derivation device according to claim 1, wherein the at least one processor is configured to execute the instructions to:
manage each of the abstract configurations obtained by applying the embodiment rule to the new configuration and the abstract configuration one or more times in association with the second evaluation value,
preferentially select an abstract configuration the higher the similarity indicated by the second evaluation value, and
repeat application of the embodiment rule to the selected abstract configuration.

4. The system configuration derivation device according to claim 1, wherein the at least one processor is configured to execute the instructions to select an abstract configuration based on a third evaluation value of the certainty of obtaining an embodiment configuration from an abstract configuration by repeatedly applying an embodiment rule to the abstract configuration, in addition to the second evaluation value.

5. A system configuration derivation device comprising:
at least one memory configured to store instructions; and
at least one processor configured to execute the instructions to:
associate an evaluation value of a similarity between a first application of an embodiment rule and a second application of an embodiment rule with an embodiment configuration obtained from a new configuration, wherein (d1) the first application of the embodiment rule is obtained in a process of obtaining an embodiment configuration by repeatedly applying an embodiment rule to input of the new configuration including the abstract element, the embodiment configuration being a system configuration not including an abstract element, and wherein (d2) the second application of the embodiment rule is included in a design history indicating a history of the embodiment configuration obtained by repeatedly applying the embodiment rule to an abstract configuration which is a system configuration including the abstract element; and
output the evaluation value of the similarity.

6. A system configuration derivation method performed by a computer, the method comprising:
calculating a first evaluation value indicating an evaluation of a similarity between a specific embodiment rule application and a candidate of the embodiment rule application, wherein the specific embodiment rule application is included in a design history, the design history indicates a history of in a case where an embodiment configuration is obtained by repeatedly applying an embodiment rule to an abstract configuration, the embodiment configuration being a system configuration not including an abstract element and the abstract configuration being a system configuration including an abstract element, and the candidate of the embodiment rule application is used for a new configuration in a case where determining the embodiment configuration, the new configuration being the abstract configuration of a system design target;
selecting, based on a second evaluation value, a specific abstract configuration among the abstract configurations obtained by applying the embodiment rule to the new configuration one or more times, wherein the second evaluation value indicates the evaluation of the similarity with the design history, of the entirety of one or more applications of the embodiment rule until the abstract configuration is obtained from the new configuration; and
repeating the embodiment rule application to the selected specific abstract configuration.

7. (canceled)
